(19) United States
(12) Patent Application Publication
(10) Pub. No.: US 2011/0050412 A1
(43) Pub. Date: Mar. 3, 2011

(54) Voice activated finding device

(76) Inventors: Cynthia Wittman, New York, NY (US); Gabe Neiser, Port Jefferson, NY (US); Michael Keating, Hardwick, NJ (US)

(21) Appl. No.: 12/806,056

(22) Filed: Aug. 4, 2010

Related U.S. Application Data
(60) Provisional application No. 61/274,461, filed on Aug. 18, 2009.

(51) Int. Cl. G08B 1/08; G10L 15/00

(52) U.S. Cl. 340/539.32; 704/231; 704/E15.001

(57) ABSTRACT

Selected objects may be located by pushing a button on a keypad of a base unit, or by giving an oral command thereto. A receiver microprocessor, loaded with a unique electronic address, is attachable to each object. A base unit PROM is loaded with a library of digitized voice command templates. A user's command to find a lost object is received by a microphone, and digitized. The digitized command is compared with the templates using pattern recognition algorithms, which may utilize a Hidden Markov Model. When matched, the base unit processor causes radio transmission of RF interrogation packets targeted at the unique address corresponding to the lost object. A receiver chip detects the interrogation packets, and compares the transmitted unique address with the address stored in its microprocessor. Where matched, the microprocessor modulates a sounding device to direct the user to the lost object. The voice command templates can be preset for speaker independent operation or can be customizable for speaker dependent operation.

### CROSS REFERENCES TO RELATED APPLICATIONS

This application claims priority on U.S. Provisional Application Ser. No. 61/274,461, filed on Aug. 4, 2009, the disclosures of which are incorporated herein by reference.

### FIELD OF THE INVENTION

The present invention relates to improvements in systems and devices used for locating objects, particularly for systems which utilize transceivers or receivers being fixable to selected objects susceptible to mislocation, and being locatable once lost by voice or push-button command.

### BACKGROUND OF THE INVENTION

Devices used for locating lost personal belongings are known in the art. It is a common occurrence for individuals to leave items such as keys, remote controllers and other such belongings, in a particular location and then when it comes time to use such items, he/she cannot recall the location where the item was last placed. Consequently, the individual will search relentlessly for the misplaced item, expecting that he will remember where he last placed the item. In a case in which the individual is unable to find the misplaced item or items, they may have to be replaced at a cost to the individual.

There have been a number of prior art devices that have endeavored to solve the problem of locating misplaced personal belongings. One such article locating system comprises a sending unit and a receiving unit. The receiving unit is attached to a desired article. The sending unit is created to activate the receiving unit by releasing a locator signal which is transmitted to the receiving unit. To use it the individual must press the find button on the sending unit. The receiving unit then responds with a distinctive tone and/or flashing lights enabling the individual to locate the misplaced belonging. Unfortunately, in order for this system to be successful the individual must always be aware of the location of the sending unit. Therefore, if the individual misplaces the article with the receiving unit attached and similarly misplaces the sending unit, the system will be useless and he will have to resort to primitive means of searching for the misplaced article.

Another such locating system does not require both a receiving and sending unit. The system consists of a device which is attached to a desired article. The device responds to a whistle or clapping sound with a distinctive tone and/or a flashing light. Therefore, in the event that a user misplaces the article on which the device is attached, the user either whistles or claps his hands loudly and the device will alert the user to the location of the misplaced item by a distinctive tone and/or a flashing light. The weaknesses of this locating system is that because a device is activated by a whistle and or clapping sound it can be frequently activated inadvertently by stray sound signals. Such inadvertent activation may occur in business meetings or other engagements in which decorum is required. Further, frequent accidental activation can cause unnecessary drain on the battery.

Despite the prior art described above, the problem of locating misplaced personal belongings still remains. As a result, many individuals waste precious time hunting for misplaced belongings. Wasted time searching can lead to various unfortunate occurrences such as missing appointments and travel departures along with other time sensitive engagements.

### SUMMARY OF THE INVENTION

The present invention solves the problem of finding misplaced items. It allows an individual to find his or her misplaced belongings by voice commands, such as: “Where are my keys?” or “Find my remote,” or simply “Glasses.” Since the invention is activated by voice, it resolves the problem in the above-described system in which the individual must be able to locate the sending unit in order to find the misplaced item. Further, the present invention has the ability to locate multiple items. The system includes a base station along with one or more receivers/transceivers (The system could utilize either receivers that simply beep and light up when their unique ID code is received, or in the form of a transceiver they could message back to the base station that they have been successfully located; hence the use of receiver/transceiver). A receiver/transceiver may be attached to specific items the user wished to always be able to quickly locate, such as remote controls (DVD, satellite, DVR, CD player, radio remote, garage opener, etc.), a camera, a check book, a cell phone, an MP3 player, an address book, a day planner, etc.

The base station is responsible for transmitting radio interrogations to specific receivers upon a command. Commands can be a button press or a voice command. Preferably there are four receivers to permit the user to locate a variety of items. In another embodiment there are up to 8 receiver units which can be plugged into the base station to be charged or programmed. Additional receivers can be included and integrated into the base station, if desired. Although the preferred embodiment illustrates four (4) or eight (8) receivers/transceivers, any one familiar with the art can see that any number of receivers/transceivers could be implemented. These receivers are preferably battery operated and rechargeable and the base station will include circuitry to remind the user when it is time to recharge a particular receiver; this eliminates the problem in the above-described whistle/clap system in which inadvertent activation risks the drain on the battery. The preferred embodiment illustrates the use of rechargeable batteries yet primary (non-rechargeable) type batteries may be used as is obvious to anyone familiar with the art. Moreover, since it is activated by voice and not a clapping or whistling sound it will rarely be susceptible to inadvertent activation.

### BRIEF DESCRIPTION OF THE DRAWINGS

FIG. 1 is a representative example block diagram showing the components of the Base Station of the current invention, and related block diagrams for various remote FOBs.

FIG. 2 is a representative example of a flowchart showing the overall logic of the software upon a base station cold start, in relation to providing service to the user.

FIG. 3 is a representative example of a flowchart showing the logic of the software, which transitions from FIG. 2 when the user request was to “Find” an item.

FIG. 4 is a representative example flowchart showing the logic of the software, which transitions from FIG. 2 when the user request was to “Program” a locator.

FIG. 5 is a representative example of a flowchart showing the logic of the software, which transitions from FIG. 2 when the user requested “Settings” to adjust or examine system settings.

FIG. 6 is a representative example of a flowchart showing the logic of the software, which transitions from FIG. 5 when the user request was “Speaker” to adjust speaker volume, etc.

FIG. 7 is a representative example of a flowchart showing the logic of the software, which transitions from FIG. 5 when the user request was “List,” seeking to have the software list the names of the locators programmed in memory.

FIG. 8 is a representative example of a flowchart showing the logic of the software, which transitions from FIG. 5 when the user request was “Clear,” seeking to erase all locator data stored in memory.

FIG. 9 is a representative example of a flowchart showing the overall logic of the software upon a base station cold start, in relation to initialization of the unit.

FIG. 10 is a representative example of a top perspective view of an embodiment of a base unit.

FIG. 11 is a representative example of a bottom perspective view of the base unit of FIG. 10.

FIG. 12 is a representative example of an exploded view of the base unit of FIG. 10.

FIG. 13 is a representative example of a top perspective view of an embodiment of a receiver, with it being in the form of a FOB.

FIG. 14 is a representative example of a bottom perspective view of the receiver of FIG. 13.

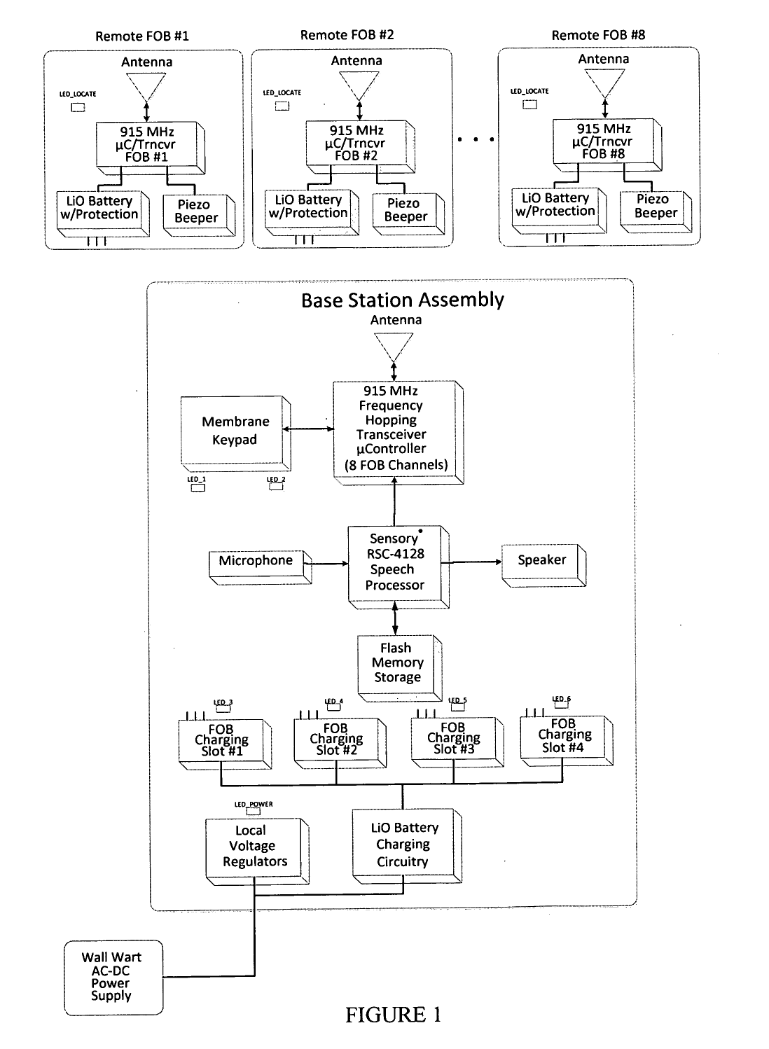

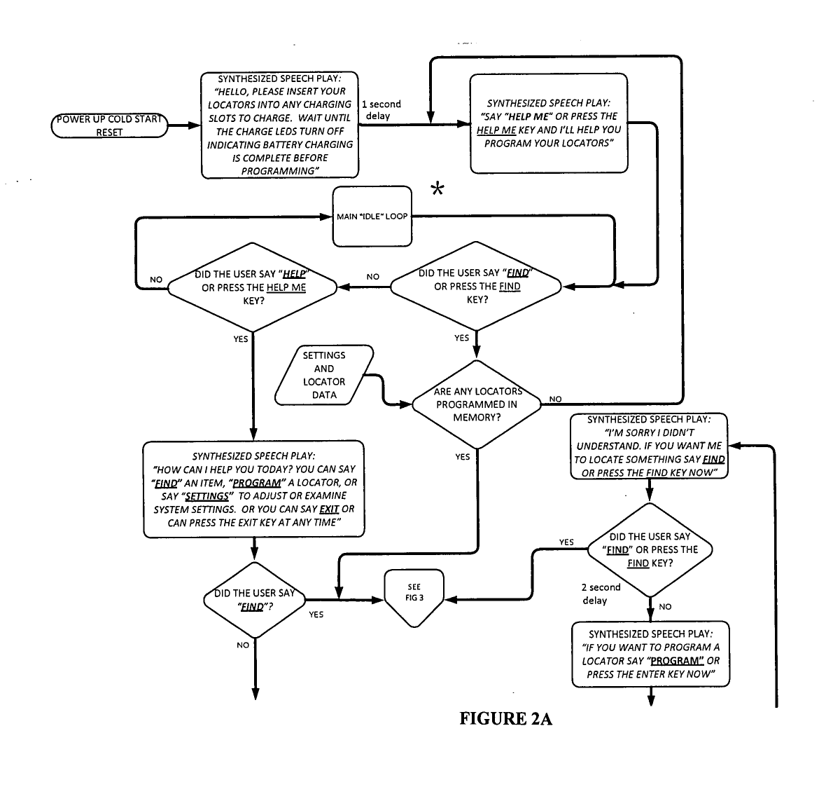

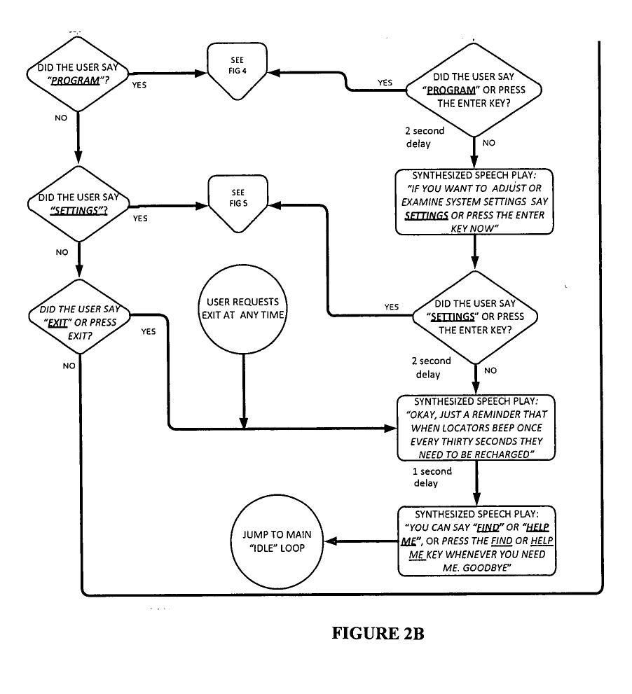

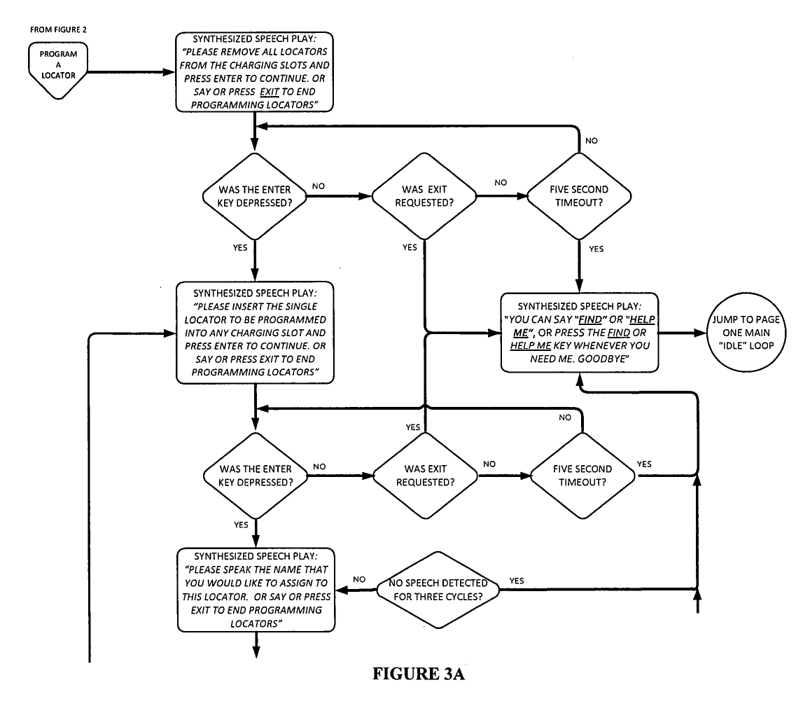

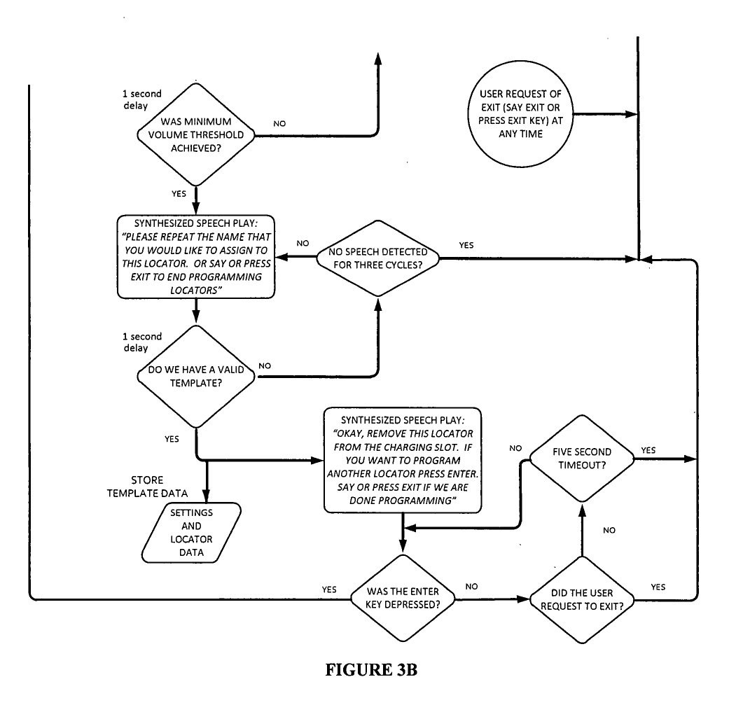

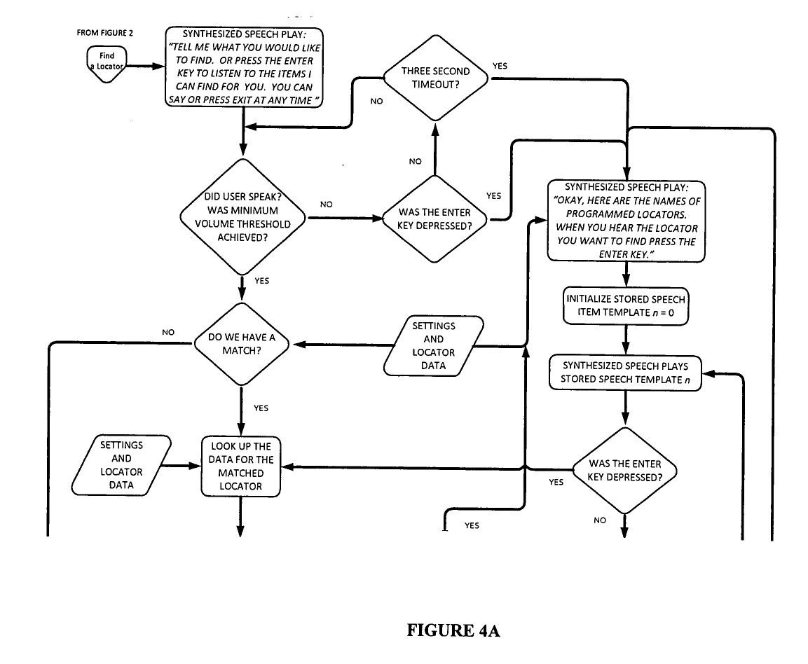

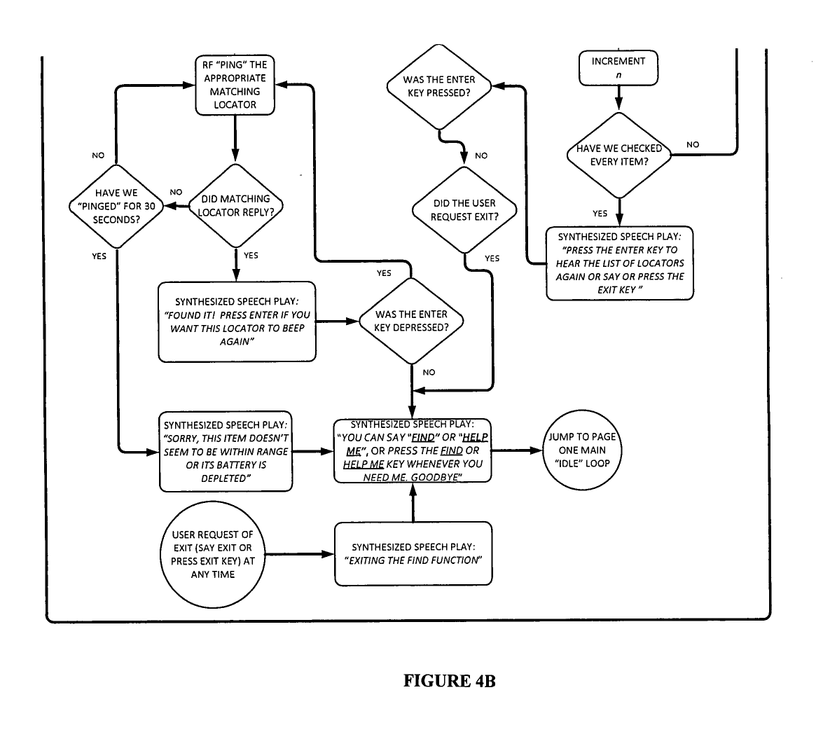

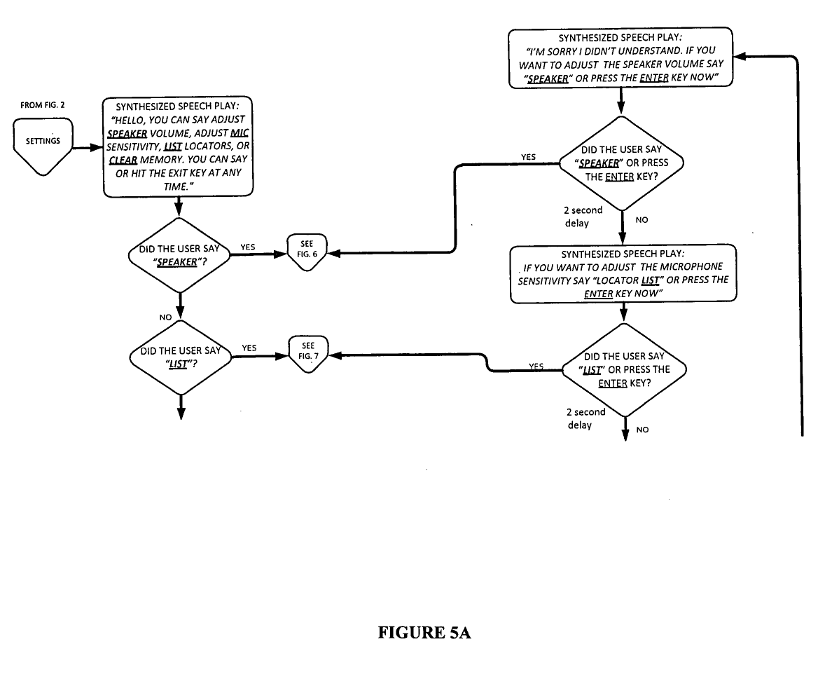

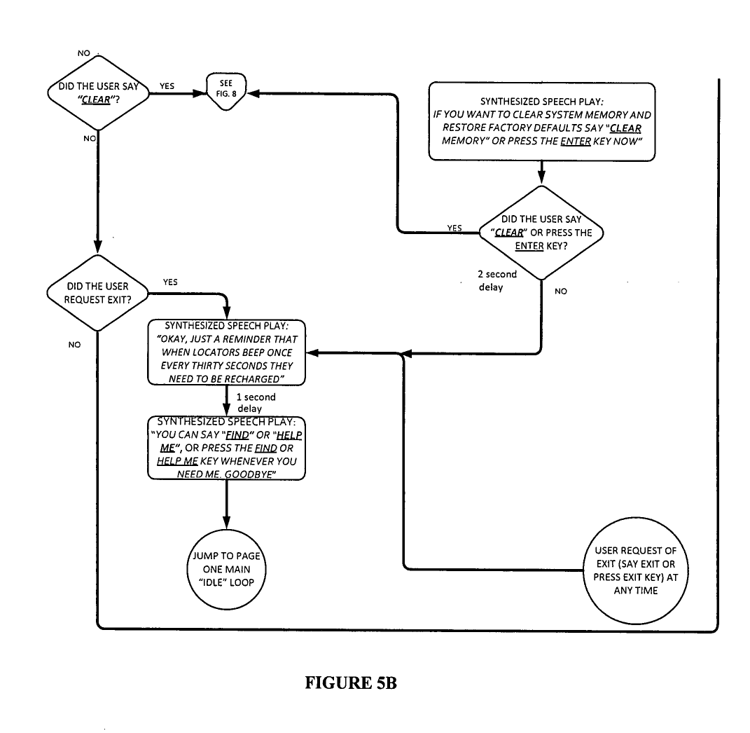

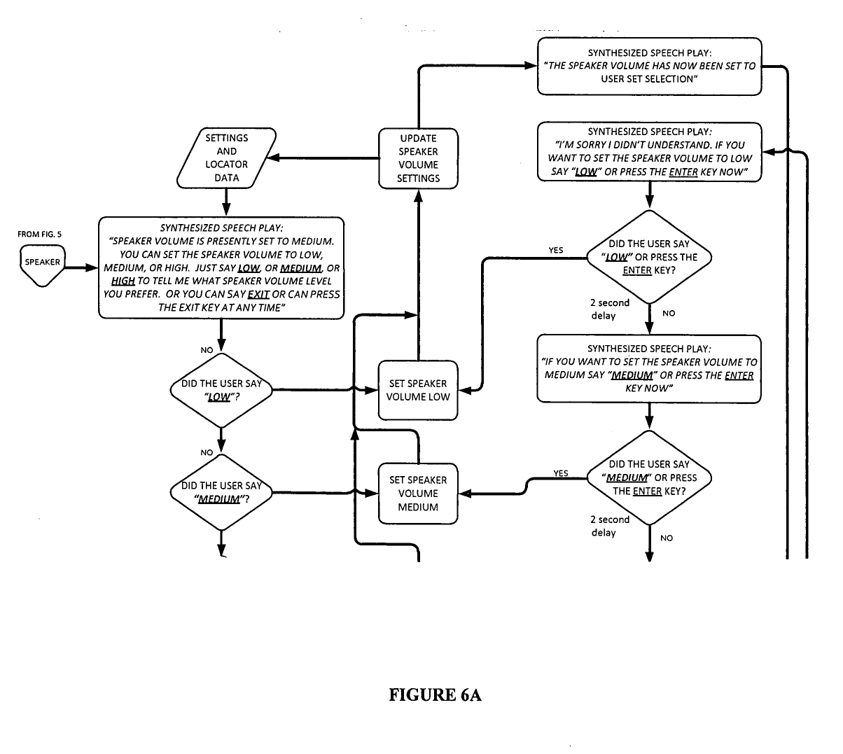

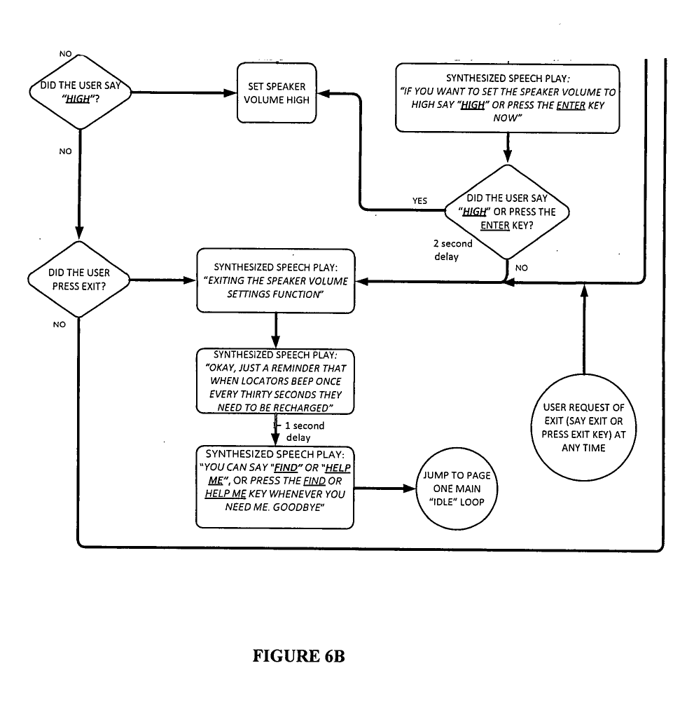

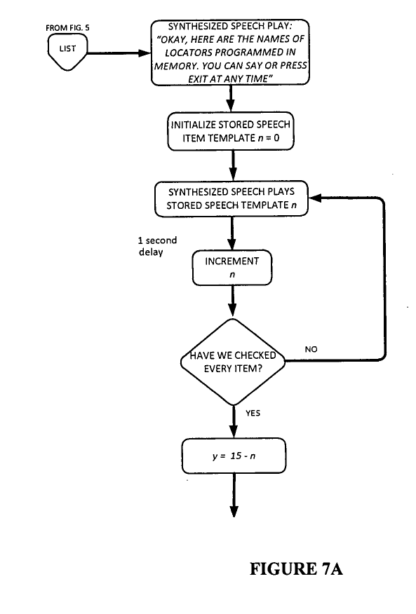

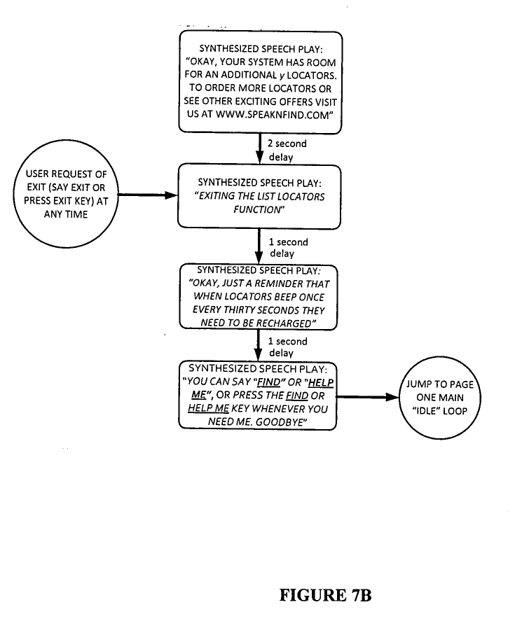

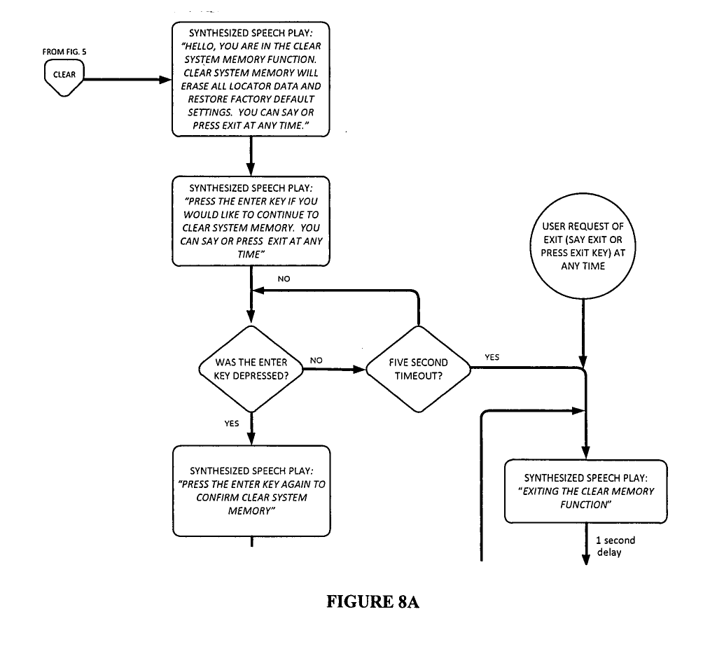

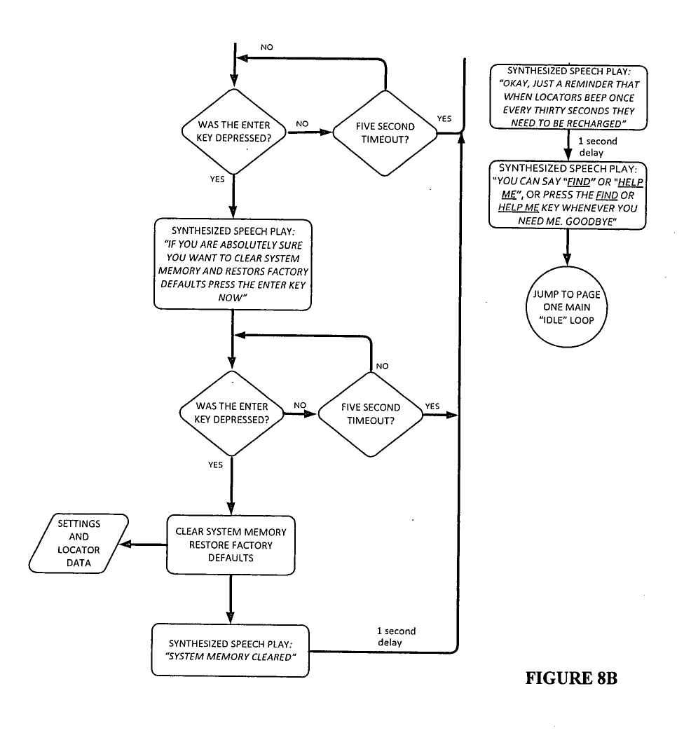

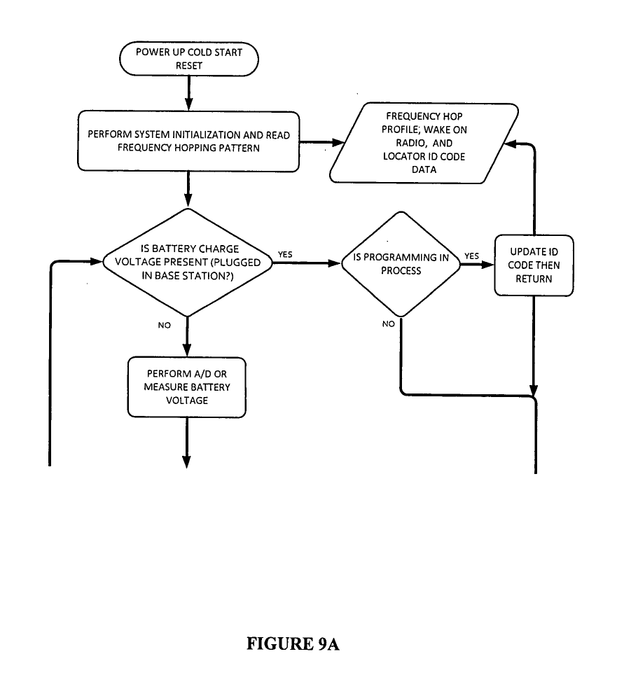

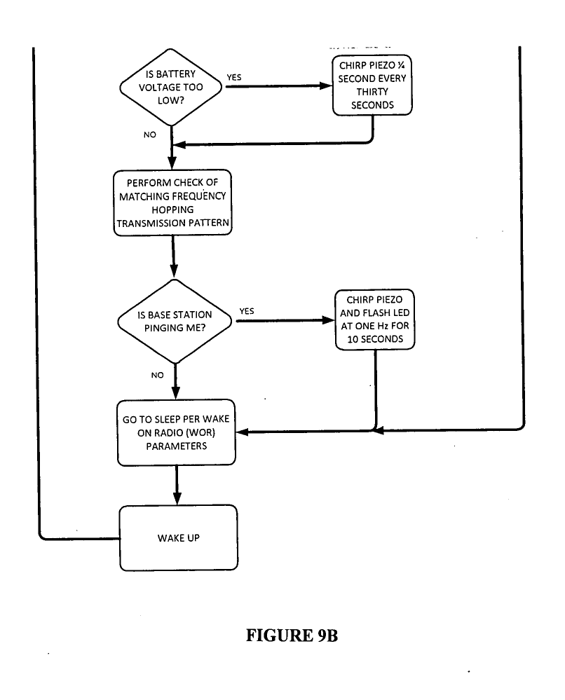

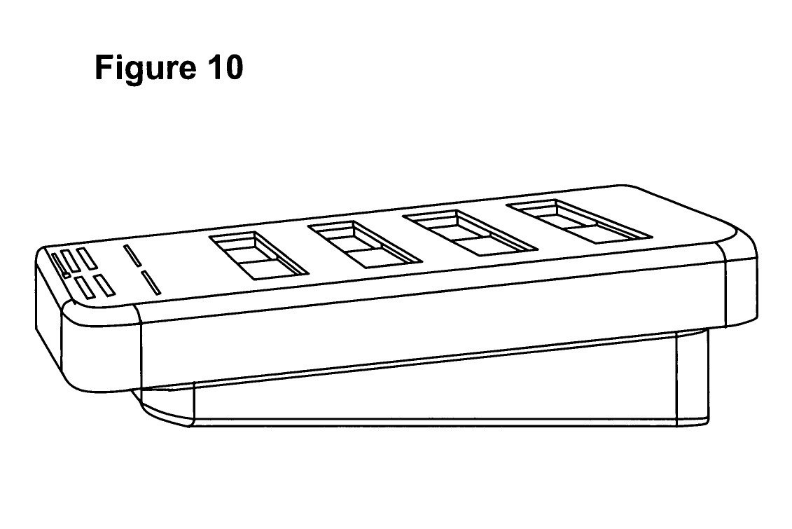

It will be appreciated by those skilled in the art that the drawing figures are examples of one embodiment of the present invention and that other embodiments using the teaching of the present invention are possible.

### DETAILED DESCRIPTION OF THE INVENTION

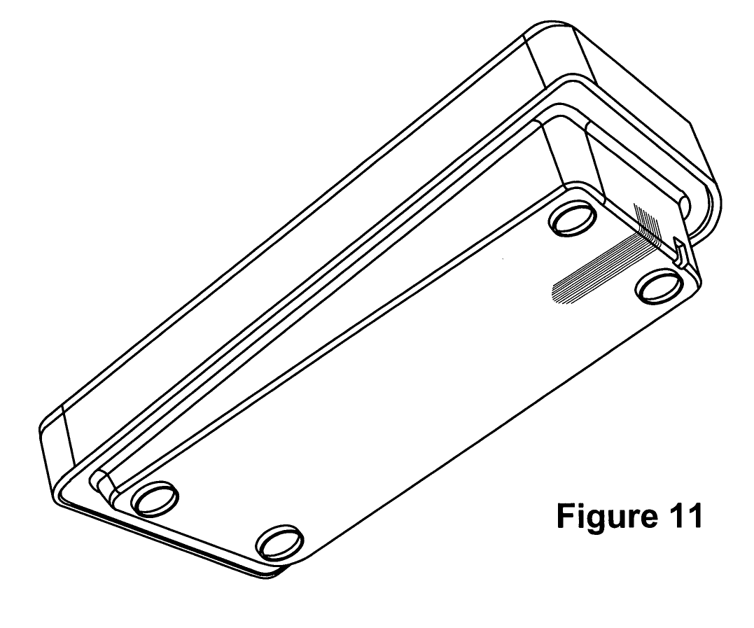

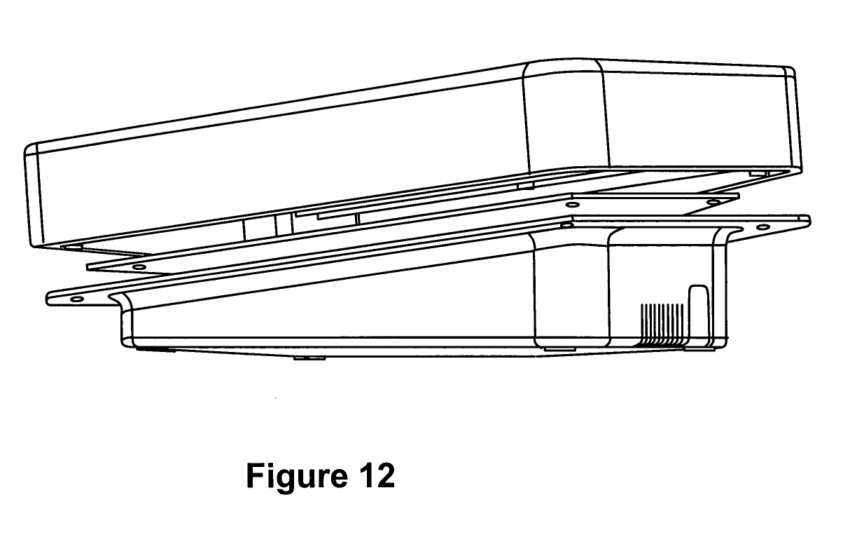

The present invention preferably includes a key-fob receiver/interpreter and charger circuit. The device would typically include a circuit board (see also FIG. 12) that is connected to ground and a sounding device.

The chip used in the present invention is preferably a receiver IC which detects RF interrogation packets at a set frequency. The Chip may, for example, be one of the Si4311/12/13series of RF receivers that are manufactured by Silicon Labs, or may, for example, be one of the CC1110Fx/CC1111Fx SoC chips manufactured by Texas Instruments. The RF packets arrive at antenna and go through a matching network. Programming, data and control signals between a microprocessor and receiver may be determined by one or more nodes. In one embodiment, resistors distinguish different receiver addresses. However it will be generally understood that other means could be used to distinguish different receiver addresses. For example, a unique address could be loaded into microprocessor.

The central processor of the base station of the present invention is preferably a Sensory RSC4128 chip. This processor is preferably a dedicated programmable processor similar in architecture to a digital signal processor and its core functionality is that of speech synthesis and recognition. The processor is preferably programmable to have a plurality of features. Two features that the processor may be programmed to have are interpreting manipulation of a keypad and processing voice commands. The processor can be programmed to scan the keypad matrix consisting of rows and columns through general purpose I/O lines on the processor for manipulation by a user. The processor can also be programmed to keep track of time, and/or control the operation of LEDS that signal to a user and regulate the radio transmitter. A speaker for voice prompts may also be controlled by the processor through a Pulse-Width Modulation (hereinafter referred to as PWM) or Digital to Analog Converter (hereinafter referred to as DAC) interface. The processor may also contain an Analog to Digital Converter (hereinafter referred to as ADC). In a preferred embodiment processor controls a speaker for voice prompts through a PWM interface, however alternate embodiments could deploy straight Digital to Analog converters. The software which runs the processor can be internal to the processor, or it can be extended to an external read-only-memory which connects to the processor by address lines and data line. In addition to activating the microphone to listen for voice commands, the processor can instruct the speaker to play a series of pre-recorded prompts and sound effects prompting the user to assist in the task at hand. These prompts and sound effect are delivered through a speaker connected to the pulse-width-modulation ports of the processor. Capacitors can filter out digital artifacts of the audio signal.

In one embodiment, the PWM interface may convert sound samples recorded from a microphone, by converting the sinusoidal speech signals into “square waves,” which may then be compared against pre-canned voice commands or user trained voice commands by comparing the pulse width between rising and falling edges of the square waves. In an alternative embodiment, the speech signals may be digitized using an analog to digital converter, and subsequently be compared to the pre-canned voice commands or user trained commands.

There is preferably a single microphone for receiving voice commands. In one embodiment, the microphone is an electret microphone with a frequency range of 100 Hz to 10,000 Hz. In a preferred embodiment, the time-varying analog microphone information can be filtered so that only audio energy in the 300 Hz to 6000 Hz is received. Microphone sensitivity can be adjusted by through biasing resistors.

In a preferred embodiment, an antenna will transmit interrogation packets at sporadic intervals at a desired frequency. It will be appreciated by those skilled in the art that although other devices operate close to the selected frequency, it is a common industry practice to only transmit interrogation packets intermittently, which minimizes the chance of interference. Furthermore, as is obvious to anyone skilled in the art the use of Frequency Hopping or Spread Spectrum radio coding techniques can be used to preclude interference detection by other systems operating in the band being transmitted by the base station. It will also be appreciated by those skilled in the art that the greater amount of interrogation packets sent out, the increased probability of the interrogation packets sent from base station finding the antenna on the receiver unit. It will also be appreciated by those skilled in the art that since the base station antenna operates at a selected frequency, the frequencies at which Wi-Fi and cordless phones operate will be avoided. It will be well within the ability of someone with ordinary skill in the art to substitute an alternative antenna which operates at a different frequency which is known to have minimal interference.

In one embodiment a button or other means is programmed to initiate the voice training program. In an alternative embodiment the button may be programmed to activate a menu system (hereinafter referred to as the menu button) which allows a user to access all of the features of the base station. After the menu button is pressed, the speaker in the base station will play prerecorded descriptions of the various programmable features of the invention. For example, one prerecorded description could be “Training Voice Commands,” or “Train command,” or “Train keyword,” or “Keyword feedback sound,” or “Listen time”. When the user wishes to activate a feature the user presses one button which is programmed to activate the feature of the invention (hereinafter referred to as the select button). Once the user presses the select button the speaker in the base station will play a pre-recorded prompt explaining to the user what to do next. For example, if the user pressed the select button after hearing “training voice commands,” the speaker in the base station will play pre-recorded prompts of the voice commands the user will be able to train. For example, in one embodiment, the speaker in the base station may play the pre-recorded prompt of “keys”, after which the processor will activate the microphone and the user can say “keys”, or “find my keys,” and the microphone will capture the user's command transmit it through the Pulse-Width Modulation of the processor and store in non-volatile memory. It is important to note that the user may train any voice command that they wish, and are not restricted to the prerecorded prompt. Once a user has trained a command, the “training voice commands” feature will direct the speaker in the base station to play the voice command the user has trained from the non-volatile memory, instead of the prerecorded prompts stored in the firmware. A user may re-record over a command they have already trained by speaking a new command into the microphone in the base-unit after hearing their previously recorded command, or they may skip over that command by pressing the select button to record a different command.

The base station is able to recognize voice commands from the user by neural networking algorithms installed in the firmware which employ a Hidden-Markov Model; or other common statistically based voice recognition algorithms. These algorithms can cover speaker independent (i.e. recognizing spoken key words or phrases uttered by any individual user) as well as speaker dependent (i.e. template matching against prerecorded key words or phrases spoken by a specific user) techniques.

FIGS. 12-14 display multiple views of an example of the base station. In one embodiment, there may be a base station which manages the connections with the receivers that are wirelessly connected to the base station. The base station may be any shape desired, provided it performs the necessary function. In a preferred embodiment, the base station has a base and one or more sidewalls extending upwardly from the base. In another preferred embodiment, the base station might have a generally pyramidal structure with a truncated top surface. It will be appreciated that there may be other configurations that work equally as well. On a front face of the base station there may be one or more LED's or other signaling means that can provide information to a user about the status of the base station. These LED's are preferably recessed into the surface of the base station to protect them from damage. In addition to the LED's on the front surface there may be one or more control buttons for operating the base station. The larger button on the top is preferably a main locator button. The other button can be used to locate individual modules.

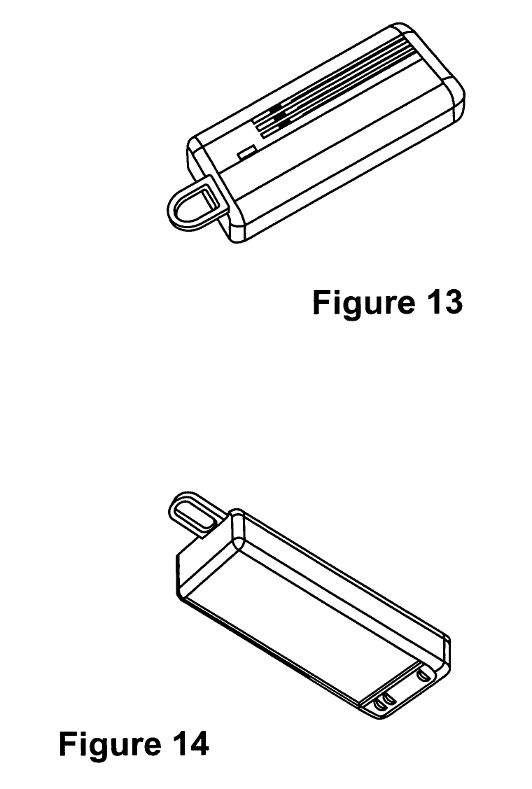

FIGS. 13-14 are an example of a perspective view of a receiver module. The receiver module is generally rectangular in configuration; but may be elliptical, round, oblong, etc. The module has a length and a width and a height. The width and height are preferably similar in length giving the receiver module a generally square or rectangular cross section.

The receiver modules or fobs are designed to be inserted into the recesses on the front face of the base station so that they can be recharged or stored when not in use; or in the case of receivers using primary non-rechargeable battery cells simply storage. The base station is also capable of direction finding and range detection and assists persons with hearing or visual disabilities.

Although the firmware and hardware of the present invention permits a user to train the base station to learn a plurality of voice commands, a user will not need to train the base station to utilize the locating function of the base and receiver units. The system will could be configured as speaker independent, speaker dependent, or a combination of both. In one method of operation, the user may attach the receiver to an item they regularly misplace without programming the base station to recognize their voice. After the user has attached the receiver to the item, the user presses one of the buttons which has been factory programmed to locate an item. When the user presses the preprogrammed button, processor registers the user's actions, then causes a microphone to activate. The user will then say the item they wish to find, such as “keys.” The microphone will record the user's voice and transmit it to processor, wherein it passes through the PWM interface, then an Analogue to Digital converter inside processor (hereinafter referred to as ADC) to create a digitized sound sample. Processor then uses this digitized sound sample to compare it to a pre-recorded library of commands to find a match. Processor will use a series of algorithms which could include and utilize a Hidden-Markov Model (HMM) to find a match. As stated other common statistically based voice recognition algorithms could be deployed. A HMM is a statistical model and can be considered as the simplest dynamic Bayesian network. In a regular Markov Model, the state is directly visible to an observer, so that the state transition probabilities are the only parameters. In a HMM, the state is not directly visible to an observer, but output, dependent on the state, is visible. HMMs are a popular means of temporal pattern recognition, particularly for speech, handwriting, and gesture recognition. A detailed discussion about HMMs is offered in “A Revealing Introduction to Hidden Markov Models” by Mark Stamp, at http://www.cs.sjsu.edu/faculty/stamp/RUA/HMM.pdf, the disclosures of which are incorporated herein by reference.

If the processor finds a match, it will send a series of targeted interrogation packets to a second processor. The transmitted data can be delivered from the first processor to the second processor through general purpose I/O lines. The second processor then up-converts and modulates the radio signal and delivers it to the antenna through a corresponding network. The antenna then transmits the signal to the antenna on the corresponding receiver unit that has been programmed to associate with the user's voice command. As the base station antenna is transmitting, the signal diodes can indicate that the base station is finding the item. This can include one of the diodes flashing, or any operation which would indicate to the user that the base station is finding the item. In one embodiment the processor will activate the speaker to play a pre-recorded message, such as “finding your item.” In an alternative embodiment, the processor might play a pre-recorded message such as “Finding,” then play back the digitized recording of the user's voice command in the case of speaker dependent operation, or playback the pre-recorded keyword such as “keys” in the case of speaker independent implementation. If the receiver unit is within range, the antenna on the receiver unit will pick up the interrogation packets sent from the antenna unit on the base station. The processing chip on the receiver unit will detect that the antenna is receiving a signal and instruct the speaker on the receiver unit to activate which will transmit a loud noise alerting the user to the location of the lost device. In the embodiment of the system where the remote FOB utilizes a transceiver, it would be capable of sending a signal back to the base station indicating that it was successfully communicated with the base station.

In a preferred embodiment, the radio signal is transmitted at a preselected frequency. It will be appreciated by those skilled in the art that the frequency at which the signal is transmitted can be modified so long as it penetrates walls and provides a practical range. It also may be appreciated by those skilled in the art that frequency hopping or spread spectrum communication techniques could be used to uniquely encode transmission between the base station and FOB, thereby allowing multiple systems in one home; or within radio range of each other not to falsely activate an alternate systems FOB.

In an alternative embodiment using speaker dependent methodology, a user will program the base station to recognize the voice command before executing the preceding method of operation. The user will first access the voice training system. This can be done by a programming one of buttons to access the firmware to run the voice training system directly, or through the menu system. Once the user accesses the voice training system, processor will instruct the microphone to activate and the firmware to instruct the speaker to play a pre-recorded prompt such as “keys”. The user will then say “keys”, or any other item they wish to associate with a receiver unit. Once the voice command has been programmed, the user may attach the receiver to an item they regularly misplace. After the user has attached the receiver to the item, the user presses a button or other means which has been programmed to locate an item. When the user presses the preprogrammed button, the processor registers the user's actions, then causes a microphone to activate. The user will then say the item they wish to find, such as “keys.” The microphone will record the user's voice and transmit it to the processor , wherein it passes through the PWM interface, then an Analogue to Digital converter inside the processor (hereinafter referred to as ADC) to create a digitized sound sample. The processor then uses this digitized sound sample to compare it to user recorded library of commands to find a matching template. The processor will use a series of algorithms which utilize a Hidden-Markov Model or any other modern statistically based speech recognition algorithm to find a match.

If the processor finds a match, it will send a series of targeted interrogation packets to a second processor. The transmitted data is delivered from the first processor to the second processor through general purpose I/O lines. The second processor then up-converts and modulates the radio signal and delivers it to the antenna through a corresponding network. The antenna then transmits the signal to the antenna on the corresponding receiver unit that has been programmed to associate with the user's voice command. As the base station antenna is transmitting the signal diodes indicate that the base station is finding the item. This can include one of diodes flashing, or any operation which would indicate to the user that the base station is finding the item. In one embodiment the first processor will activate the speaker to play a pre-recorded message, such as “finding your item.” In an alternative embodiment, processor might play a pre-recorded message such as “Finding,” then play back the digitized recording of the user's voice command. If the receiver unit is within range, the antenna on the receiver unit will pick up the interrogation packets sent from the antenna unit on the base station. The processing chip on the receiver unit will detect that the antenna is receiving a signal and instruct the speaker on the receiver unit will activate which will transmit a loud noise alerting the user to the location of the lost device. In the embodiment of the system where the remote FOB utilizes a transceiver, it would be capable of sending a signal back to the base station indicating that it was successfully communicated with the base station.

We claim:

1. A method of locating one or more selected objects comprising the steps of: using one or more processors to execute instructions retained in machine-readable media to perform at least some portion of the following steps:
(a) attaching a receiver to each of said one or more selected objects; each of said receivers comprising a unique electronic address loaded into a microprocessor therein, said unique address electronically distinguishing each receiver from all other receivers attached to said selected objects;
(b) loading instructions into a PROM of a programmable processor on a circuit board located in a base unit;
(c) loading a pre-recorded library of command templates into said PROM, each of said templates corresponding to one of said unique receiver addresses;
(d) receiving a command requesting said base unit to locate a lost one of said one or more selected objects;
(e) responding to said command by a radio transmitter causing a series of antenna transmissions; said series of transmissions being directed at said unique receiver address corresponding to said lost object;
(f) detecting said series of transmissions by said receiver using a receiver chip;
(g) comparing said transmitted unique address to said unique address in said receiver microprocessor of said lost object; and
(h) wherein when said transmitted unique address matches said unique address stored in said microprocessor, said microprocessor responding by emitting a signal.

2. The method according to claim 1, wherein said radio transmitter causing a series of antenna transmissions comprises transmission of RF interrogation packets.

3. The method according to claim 2, wherein said series of RF interrogation packets comprise RF interrogation packets transmitted at sporadic intervals.

4. The method according to claim 3, wherein said command templates are from the group consisting of: digitized voice command templates; and command templates corresponding to pushing of a button switch on a keypad on said base unit.

5. The method according to claim 4, wherein said keypad comprises a plurality of programmable push-button switches.

6. The method according to claim 5, wherein at least one of said plurality of button switches is programmable to automatically transmit said RF packets to one of said unique addresses in said receivers on said selected objects.

7. The method according to claim 6, wherein one or more buttons of said plurality of buttons is programmable to perform specific base unit functions, said specific base unit functions comprising: resetting all non-volatile memory to factory defaults; instructing a speaker to recite the time; initiating a voice training program; activating a menu system to access all base station features; and playing a prerecorded description of programmable features of said base unit.

8. The method according to claim 7, wherein said programmable features of said base unit comprise: training voice commands; keyword feedback sounds, or listen time.

9. The method according to claim 8, wherein when said received command comprises a voice command, said command is received by a microphone in said base unit and converted using an analog to digital converter into a digitized command.

10. The method according to claim 9, wherein said digitized command is compared with said pre-recorded voice command templates, said comparison being made by said base unit processor using one or more neural network algorithms.

11. The method according to claim 10, wherein at least one of said one or more algorithms comprises a pattern recognition algorithm.

12. The method according to claim 11, wherein said pattern recognition algorithm comprises a statistically based speech recognition algorithm.

13. The method according to claim 12 wherein said pattern recognition algorithm comprises a Hidden Markov Model.

14. The method according to claim 12, wherein when said digitized command is matched to one of said pre-recorded voice command templates, said processor sends said series of targeted interrogation packets to a radio processor which then up-converts and modulates said packets into a radio signal, said transmitter delivering said signal to said antenna for said transmission of said signal.

15. The method according to claim 14, wherein said receiver/transceiver detects said RF interrogation packets using an antenna in said receiver.

16. The method according to claim 15, wherein said programmable processor is programmable for a plurality of features, said features comprising one or more of: interpreting manipulation of any of said plurality of buttons; activating said microphone to listen for voice commands; activating said voice training program; activating a menu system; processing voice commands using a digital to analog converter; keeping track of time; controlling operation of one or more LEDS; regulating said radio transmitter; and instructing said speaker to play a series of pre-recorded prompts and sound effects prompting a user to assist in a task.

17. The method according to claim 18, wherein said programmable processor comprises firmware, said firmware permitting a user to train said base unit by customizing one or more of said command templates in said library of voice command templates.

18. The method according to claim 17, wherein said customization comprises pressing said preprogrammed training button on said keypad, and pressing said button on said keypad corresponding to a receiver to be trained, and speaking one or more words into said microphone when prompted by said base unit.

19. The method according to claim 18, wherein said one or more words spoken to train said base unit button are received by said microphone and recorded therein, said microphone being activated by said processor upon pushing of said preprogrammed training button.

20. The method according to claim 19, wherein said recorded one or more words are transmitted to a pulse width modulation interface in said processor, and converted into a digitized sound sample by said analog to digital converter.

21. The method according to claim 18, wherein said customized command templates are stored in a non-volatile memory.

22. The method according to claim 21, wherein said non-volatile memory stores user preferences.

23. The method according to claim 22, wherein said receiver further comprises a FOB; said FOB being attachable to each of said one or more selected objects.

24. The method according to claim 23, wherein said FOB receiver comprises a rechargeable battery.

25. The method according to claim 24 wherein said FOB receiver comprises a non-rechargeable battery.

26. The method according to claim 24, wherein said rechargeable battery of said FOB is rechargeable by inserting said FOB receiver into a receptacle on said base unit.

27. The method according to claim 26, wherein said base unit comprises a plurality of receptacles, said plurality of receptacles being capable of simultaneously charging a plurality of said receiver FOB batteries.

28. The method according to claim 27, wherein said base unit comprises a plurality of LEDs; and wherein flashing of one of said plurality of LEDs indicates an ongoing base unit function, said base unit function comprising one or more of: charging of one or more receivers; and transmission of said RF interrogation packets to locate said receiver attached to said lost object.

29. The method according to claim 27, wherein said base unit comprises a plurality of LEDs; and wherein flashing of one of said plurality of LEDs indicates the state of charging cycle status.

30. The method according to claim 28, wherein each of said receiver FOBs comprise an LED; and wherein said LED flashes upon said transmitted unique address matching said unique address in said receiver microprocessor.

31. The method according to claim 30, wherein said base unit further comprises a voltage regulator; and wherein said voltage regulator provides power for said base station from an electrical connection with a low voltage unregulated wall supply.

32. The method according to claim 31, wherein said power to said base unit is from one or more back-up batteries.

33. The method according to claim 32, wherein said one or more back-up batteries serve as a fail safe power supply.

34. The method according to claim 33, wherein said back-up batteries permit portability of said base unit to thereby allow said user to walk around while said base unit transmits said RF interrogation packets to locate said receiver attached to said lost object.

35. The method according to claim 34, wherein said sounding device on said receiver comprises a Piezo beeper.

36. The method according to claim 35, wherein said sporadically transmitted series of RF interrogation packets are transmitted at frequencies that avoid common wireless products, said common wireless products being from the group consisting of: cordless phones, Bluetooth wireless products, Wi-Fi devices and frequency hopping/spread spectrum techniques.

37. The method according to claim 36, wherein said sporadically transmitted series of RF interrogation packets are transmitted at a frequency in the range of about 433 MHz to 2.4 GHz.

38. The method according to claim 1 wherein said microprocessor responds to said unique address by modulating a sounding device,

39. The method according to claim 1 wherein said microprocessor respond to said unique address by illuminating a light source.

40. The method according to claim 1 where said microprocessor responding to said unique address by signaling back to the base station the successful reception of said transmitted unique address.

41. An article of manufacture comprising a program storage medium having computer readable code embodied therein, said computer readable code being operable in a process for controlling functions of a device capable of selectively transmitting radio interrogations to aid in locating one of a plurality of selected objects, said process comprising:
(a) attaching a receiver to each of said plurality of selected objects; each of said receivers comprising a unique electronic address loaded into a microprocessor therein, said unique address electronically distinguishing each receiver from all other of said plurality of receivers;
(b) loading said computer readable code into a programmable read-only memory of a programmable processor, said processor being located on a circuit board in a base unit, said computer readable code comprising a pre-recorded library of command templates, each of said templates corresponding to one of said unique receiver addresses;
(c) receiving a command, said command being for said base unit to locate a lost one of said one or more selected objects;
(d) responding to said command by a radio transmitter causing a series of antenna transmissions; said series of transmissions being directed at said unique receiver address corresponding to said lost object;
(e) detecting said series of transmissions by said receiver using a receiver chip;
(f) comparing said transmitted unique address to said unique address in said receiver microprocessor of said lost object; and
(g) wherein when said transmitted unique address matches said unique address stored in said microprocessor, said microprocessor responding by modulating a sounding device of said receiver.

42. The article according to claim 41, wherein said radio transmitter causing a series of antenna transmissions comprises transmission of RF interrogation packets at sporadic intervals.

43. The article according to claim 42, wherein said command templates are from the group consisting of: digitized voice command templates; and command templates corresponding to pushing of a button switch on a keypad on said base unit; and wherein said keypad comprises a plurality of programmable push-button switches.

44. The article according to claim 43, wherein at least one of said plurality of button switches is programmable to automatically transmit said RF packets to one of said unique addresses in said receivers on said selected objects.

45. The article according to claim 44, wherein one or more buttons of said plurality of buttons is programmable to perform specific base unit functions, said specific base unit functions comprising: resetting all non-volatile memory to factory defaults; instructing a speaker to recite the time; initiating a voice training program; activating a menu system to access all base station features; and playing a prerecorded description of programmable features of said base unit.

46. The article according to claim 45, wherein when said received command comprises a voice command, said command is received by a microphone in said base unit and converted using an analog to digital converter into a digitized command.

47. The article according to claim 46, wherein said digitized command is compared with said pre-recorded voice command templates, said comparison being made by said base unit processor using one or more neural network algorithms.

48. The article according to claim 47, wherein at least one of said one or more algorithms comprises a pattern recognition algorithm utilizing a statistically based speech recognition algorithm.

49. The article according to claim 47, wherein at least one of said one or more algorithms comprises a pattern recognition algorithm utilizing a Hidden Markov Model.

50. The article according to claim 42, wherein when said digitized command is matched to one of said pre-recorded voice command templates, said processor sends said series of targeted interrogation packets to a radio processor which up-converts and modulates said packets into a radio signal, said transmitter delivering said signal to said antenna for said transmission of said signal.
